(19) United States
(12) Patent Application Publication
(10) Pub. No.: US 2025/0326090 A1
(43) Pub. Date: Oct. 23, 2025

(54) QUICK RELEASE ADJUSTABLE PLIER

(71) Applicant: STANLEY BLACK & DECKER INC., New Britain, CT (US)

(72) Inventors: David P. ENGVALL, Stanley (NC); Pavel DUGIN, Catonsville, MD (US)

(21) Appl. No.: 18/640,906

(22) Filed: Apr. 19, 2024

(51) Int. Cl. B25B 7/10

(52) U.S. Cl. CPC B25B 7/10

(57) ABSTRACT

A device for clamping an object with adjusting plier mechanism is disclosed. In particular, a device is provided with a top jaw having a bottom handle, a slot, and a series of ridges located around the slot and top handle with a distal end. A pawl pivot, which includes an engagement element, is provided for extending through the bottom jaw and into a slot of the top jaw. The bottom jaw can include a slot for receiving at least part of the top jaw and bottom handle. The top jaw can include a slot for receiving at least part of the pawl pivot. The top jaw and bottom jaw pivot about a first axis of the coupling element, and the engagement element is moveable along a different axis from a first position to a second position.

### I. CROSS-REFERENCE TO RELATED APPLICATIONS

This application claims priority to PCT Patent Application No. PCT/US2021/071936, filed on Oct. 20, 2021, which is incorporated herein by reference in its entirety.

### II. FIELD OF THE INVENTION

The present invention relates generally to plier devices, and more particularly, to plier devices that can be quickly adjusted to several positions.

### III. BACKGROUND OF THE INVENTION

Adjustable pliers, also called “water pump pliers” or “groove joint pliers” are common tools used by all trades. They are versatile tools for a variety of gripping, torqueing, pulling, bending, etc. processes. A key feature of adjustable pliers is a wide range of jaw openings achieved by multiple positions for the pivot between the jaws.

Numerous arrangements have been developed over the years to adjust and retain the pivot between the jaws at the selected position. Traditional methods include arcuate grooves that engage between the jaws and a pivot pin with a flat side adjustable between connected circular openings. More modern examples of adjustable pliers utilize quicker and/or finer adjustment methods. Examples of a modern adjustable pliers are described in the following four patents:

U.S. Pat. No. 7,040,201 is directed toward a method and device is disclosed for clamping an object with quick adjusting pliers. A top jaw has a bottom handle, a slot, and a series of ridges located around the slot. A pin extends through the slot and includes an engagement element. A bottom jaw has a top handle and another opening for receiving the pin. The engagement element engages at least one of the series of ridges in a first position, wherein the top jaw and bottom jaw pivot about a first axis that extends through a longitudinal axis of the pin, and wherein the engagement element is moveable along the first axis from the first position to a second position wherein the engagement element does not engage any of the series of ridges.

U.S. Pat. No. 7,089,832 is directed toward a method and device is disclosed for clamping an object with quick adjusting pliers. A top jaw has a bottom handle, a slot, and a series of ridges located around the slot. A pin extends through the slot and includes an engagement element. A bottom jaw has a top handle and another opening for receiving the pin. The engagement element engages at least one of the series of ridges in a first position, wherein the top jaw and bottom jaw pivot about a first axis that extends through a longitudinal axis of the pin, and wherein the engagement element is moveable along the first axis from the first position to a second position wherein the engagement element does not engage any of the series of ridges.

U.S. Pat. No. 7,100,480 is directed toward a device and method for clamping an object with quick adjusting pliers. In particular, a device is provided with a top jaw having a bottom handle, a slot, and a series of ridges located around the slot. A pin is provided for extending through the slot. A tongue element is also provided with a first opening for receiving the pin. In addition, a bottom jaw is provided with a top handle and another opening for receiving the pin. The tongue element engages one of the series of ridges. The top jaw and bottom jaw pivot about a first axis of the pin, and the tongue element is moveable relative to the series of ridges to allow for engagement or disengagement of the ridges.

U.S. Pat. No. 7,293,485 is directed toward a device and method for clamping an object with quick adjusting pliers. In particular, a device is provided with a top jaw having a bottom handle, a slot, and a series of ridges located around the slot. A pin, which includes an engagement element, is provided for extending through the slot. In addition, a bottom jaw is provided with a top handle and another opening for receiving the pin. The top jaw and bottom jaw pivot about an axis of the pin, and the engagement element is moveable along the same axis from a first position wherein the engagement element engages at least one of the series of ridges to a second position wherein the engagement element does not engage any of the series of ridges.

While the modern adjusting pliers above provide for quick adjustment, there exists a need for an adjusting plier providing ambidextrous tool handling, increased jaw span adjustment capability, increase jaw position range, and, and smaller jaw footprint to allow for access to tighter spaces. The prior mentioned adjusting pliers lack these features. Therefore, there exists a need for an improved adjusting plier.

### IV. SUMMARY OF THE INVENTION

Pliers are known for gripping articles and for applying a turning force to an article. Pliers typically comprise a pair of members pivoted to one another for relative movement. Usually one end of the members include jaws for gripping the article and the other end of the members are formed as handles for manually applying a gripping force to the jaws and a turning force to the pliers. Mechanisms are known for adjusting the distance between the jaws to allow the jaws to grip articles of varying size. One type of mechanism allows the user to push a button or lever to release the engagement of the members from one another and to allow the jaws to be moved relative to one another to adjust the spacing. An improved adjusting pliers stabilizing and/or alignment features is desired.

The present invention provides a device and method for clamping an object with adjusting pliers. In particular, a device is provided with a top jaw having a bottom handle, a slot and a series of ridges, wherein the ridges are located around the slot; a pawl pivot that extends through the slot, where the ridges are located around the slot; a top handle, the top handle having distal ends including bores, a bottom jaw, the bottom jaw having a plurality of recesses and an opening, wherein the bottom jaw is attached to the adjusting plier by the pawl pivot extending through the bores of the top handle and the slot of the top jaw, the pawl pivot having an engagement element, wherein the engagement element engages at least one of the series of ridges in a first position, wherein the top handle and the bottom jaw pivot about a first axis that extends through a longitudinal axis of the coupling, connecting or joining element, such as a rivet or pin, and wherein the engagement element is rotatably around a third axis from the first position to a second position wherein the engagement element does not engage any of the series of ridges.

In an alternative embodiment, the plier device is provided with a top jaw having a bottom handle, a slot and a series of ridges, wherein the ridges are located around the slot, a pawl pivot that extends through the slot, where the ridges are located around the slot, a top handle, the top handle having distal ends including bores, a bottom jaw, the bottom jaw defining a plurality of spaces within said bottom jaw for receiving the top jaw and the top handle, an engagement element attached to the pawl pivot, wherein the engagement element engages at least one of the series of ridges in a first position, wherein the top jaw and the bottom jaw pivot about a first axis that extends through a longitudinal axis of the pawl pivot, and wherein the engagement element is movable along a third axis from the first position to a second position wherein the engagement element does not engage any of the series of ridges.

In yet another alternative embodiment, the plier device is provided with a top jaw having a bottom handle, a slot and a series of ridges, wherein the ridges are located around the slot, a pawl pivot that extends through the slot, where the ridges are located around the slot, a top handle, the top handle having distal ends including bores, a bottom jaw, the bottom jaw having a plurality of spaces within said bottom jaw for receiving the top jaw and the top handle, an engagement element connected to the pawl pivot, wherein the engagement element engages at least one of the series of ridges in a first position, wherein the top jaw and the bottom jaw pivot about a first axis that extends through a longitudinal axis of the coupling, connecting or joining element, such as a rivet or pin, and wherein the engagement element is movable along a third axis from the first position to a second position wherein the engagement element does not engage any of the series of ridges.

In another embodiment, at least one part of the pawl pivot includes a stop element for engaging at least part of one plier handle for stopping movement of at least one plier jaw.

In at least one embodiment of the present invention, there is an adjusting plier device comprising a top jaw having a slot with a series of ridges and a bottom handle, wherein the ridges are located on at least one inner surface of the slot, a pawl pivot that extends through at least one jaw, wherein at least part of the pawl pivot is configured to engage a plurality of the ridges located in the slot, a bottom jaw, the bottom jaw having an opening and a top handle, wherein the bottom jaw is a part of the adjusting plier by the pawl pivot extending from part of the bottom jaw into the slot of the bottom handle of the top jaw, and wherein the top jaw is configured to be operatively connected to the bottom jaw through a space between the bottom jaw and the top handle, an engagement element affixed to the pawl pivot, wherein the engagement element engages at least one of the series of ridges of the slot in a first position, wherein the top jaw and the bottom jaw pivot about a first axis, and wherein the engagement element is movable along a third axis from the first position to a second position wherein the engagement element does not engage any of the series of ridges of the top jaw.

In another embodiment of the present invention there is provided is an adjusting plier comprising a top jaw having a bottom handle, a slot, and a series of ridges, wherein the ridges are on a surface of the slot, a pawl pivot, wherein at least part of the pawl pivot extends into the slot, where the ridges are located around the slot, a bottom jaw having a top handle, the bottom jaw defining an open space within said bottom jaw and top handle for receiving the top jaw and the bottom handle, an engagement element attached to the pawl pivot, wherein the engagement element engages at least one of the series of ridges of the top jaw in a first position, wherein the top jaw and the bottom jaw pivot about a first axis, and wherein the engagement element is movable along a third axis from the first position to a second position wherein the engagement element does not engage any of the series of ridges in the top jaw.

In another embodiment of the present invention there is provided an improved adjustable plier comprising a top jaw having a bottom handle, a slot, and a series of ridges on said top jaw, wherein the ridges are on an inner surface of the slot, a pawl pivot operatively coupled to at least one jaw, wherein at least part of the pawl pivot is operatively coupled to one jaw that extends into the slot of the other jaw, wherein the ridges are located around the slot, a bottom jaw having a top handle, the bottom jaw defining an open space within said bottom jaw and top handle for receiving the top jaw and the bottom handle, an engagement element attached to the pawl pivot, wherein the engagement element engages at least one of the series of ridges in a first position, wherein the top jaw and the bottom jaw pivots about a first axis, and wherein the engagement element is movable along a third axis from the first position to a second position wherein the engagement element does not engage any of the series of ridges in the top jaw, and wherein the pivot pawl is configured to receive a force from at least one jaw, wherein the force from at least one jaw is translated onto a coupling, connecting or joining element, such as a pin or rivet of the at least one jaw to the pawl pivot and onto the teeth of the pawl pivot into a number of ridges of the slot of the corresponding other jaw. Thus, there is included the wedging engagement element inside the slot.

In another embodiment, force applied on exterior surface of the pawl pivot directs a cam engagement of the pawl pivot onto at least one jaw.

In one embodiment of the invention, the ridges are straight.

In another embodiment of the invention, the ridges are curved.

In one embodiment of the invention, the pawl teeth are straight.

In another embodiment of the invention, the pawl teeth are curved.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### V. DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 is a perspective view of an adjusting plier device according to a first embodiment of the present invention.

FIG. 2 is a partial cross-section of the adjusting plier of FIG. 1.

FIG. 3 is a partial, close-up view of a pivot pawl as shown in FIG. 2.

FIG. 4 is a top view of the adjusting plier device of FIG. 1.

FIG. 5 is an exploded view of the adjusting plier device of FIG. 1.

FIG. 6 is another exploded, perspective view of the adjusting plier device.

FIG. 7 is a perspective view of the adjusting plier device with closed jaws.

FIG. 8 is a partial side view of the adjusting plier device of FIG. 1.

FIG. 9 is a side view of the pivot pawl assembly.

FIG. 10 is an illustration of the forces on the pawl pivot shown from a cross section of the pawl pivot.

FIG. 11 is a perspective, wire frame view of a plier of FIG. 1 showing a coupling element and the jaw pivot about a number of axises.

FIG. 12 is a side view of the plier of FIG. 1 showing a slot of the top jaw as a third axis.

FIG. 13 is top, wire frame view of a cross-sectioned plier of FIG. 1 showing the pivot pawl assembly movable about a second axis.

FIG. 14 is a perspective exploded view of a pivot pawl assembly according to the embodiment of FIG. 1.

FIG. 15 is another perspective exploded view of the pawl pivot assembly.

FIG. 16 is perspective view of the pawl removed from the pivot pawl assembly.

FIG. 17 is a cross-sectioned view of the pawl showing recessed area for the bearing or engaging element.

FIG. 18 is a perspective view of an adjusting plier device according to a second embodiment of the present invention.

FIG. 19 is a side view of the adjusting plier with partial cross sectioned view of a pivot pawl assembly engaged with the slot ridges of a top jaw.

FIG. 20 is a partial cross-section of the adjusting plier of FIG. 19.

FIG. 21 is a partial, cross-section view of a pivot pawl including the bearing or engaging element as shown in FIG. 20.

FIG. 22 is a cross-sectioned, side view of an open jaw plier of FIG. 19.

FIG. 23 is a cross-sectioned, side view adjusting plier device of FIG. 18.

FIG. 24 is a close-up, partial cross-section view of the pivot pawl assembly and slot of FIG. 23.

FIG. 25 is a top view of the adjusting plier device of FIG. 18.

FIG. 26 is an exploded, perspective view of the adjusting plier of FIG. 18.

FIG. 27 is an exploded, perspective view of the pivot pawl assembly.

FIG. 28 is an exploded view of the plier tool 20.

FIG. 29 is a perspective, cross-section of the adjusting plier of FIG. 18.

FIG. 30 is a perspective cross-section view of adjusting plier.

FIG. 31 is another cross-section side view of the adjusting plier.

FIG. 32 is another cross-section side view of the adjusting plier.

FIG. 33a is a side view of the pivot pawl according to a third embodiment of the present invention.

FIG. 33b is another side view of the pivot pawl according to a third embodiment of the present invention.

FIG. 34 is a side view of an adjusting plier including the pivot pawl of FIG. 33a.

FIG. 35 is a cross-section of the entire adjusting plier of FIG. 34 showing the pivot pawl engaged with the slot ridges of the top jaw.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### VI. DESCRIPTION

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

### Embodiment 1

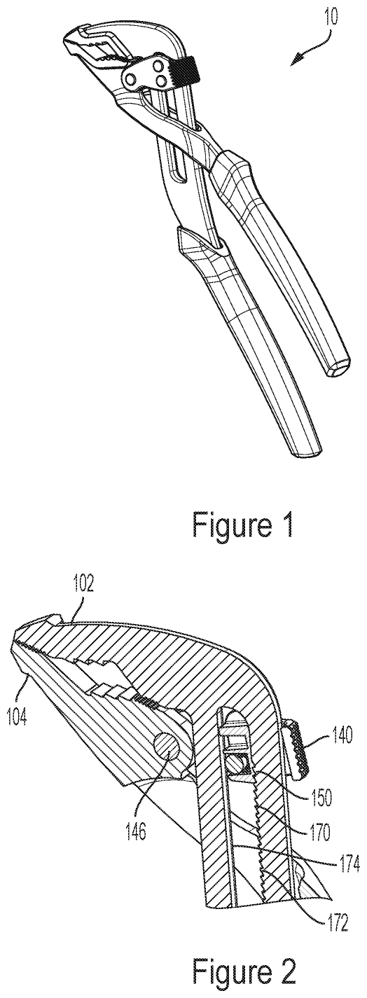

Referring to FIGS. 1 and 2, a perspective view of an adjusting plier device 10 according to a first embodiment of the present invention. The clamping on a work piece by the plier tool 10 is accomplished by squeezing a handle forcing the substantially jaws 102,104 together. The plier has the functionality of quick or easy adjusting wherein the jaws can be moved closer together by adjusting mechanism without pushing the button or tactile surface via natural disengagement of pivot pawl self-energizing mechanism moving up along third axis A3. The plier has the functionality of quick or easy adjusting wherein the jaws can be moved apart by pushing the button or tactile surface via disengagement of pivot pawl self-energizing mechanism moving down along third axis A3. The plier 10 can include haptic and audial feedback to the user along adjustment of the jaws apart and close to each other.

FIG. 2 is a partial cross-section of the adjusting plier of FIG. 1. As shown in the Figure, there is a top jaw 102, a bottom jaw 104, a pawl pivot 140, and a slot 170 in the top jaw 102. The slot 170 includes a plurality of ridges or grooves 172 configured to be engaged with the pawl pivot 140 such as being rotatable by a coupling, connecting or joining element, e.g. rivet 146, of the pawl pivot 140. The pawl pivot 140 is configured to slide on an interior slide surface 174 of the slot 170. The pawl pivot 140 is configured to adjust a bearing or engaging element, such as balls or shoes 150 on to both the surface 174 and the ridges 172 of the slot 170.

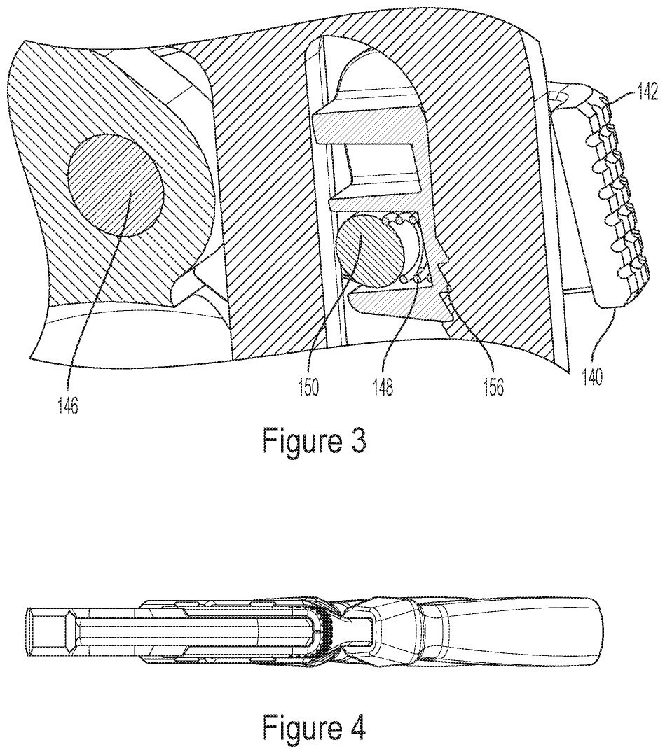

FIG. 3 is a partial, close-up view of a pivot pawl as shown in FIG. 2. Illustrated in FIG. 3 is the back wall of where the two brackets of the pawl pivot assembly 140 meet and form a tactile surface 142 and where a user can apply force onto the tactile exterior surface to cause the bearing element 150 to compress onto the spring 148 to move teeth 156 of the pawl pivot 140 from the ridges 172 of the slot 170. FIG. 4 depicts a top view of the plier 10 of FIG. 1 illustrating the tool from a bird's eye view.

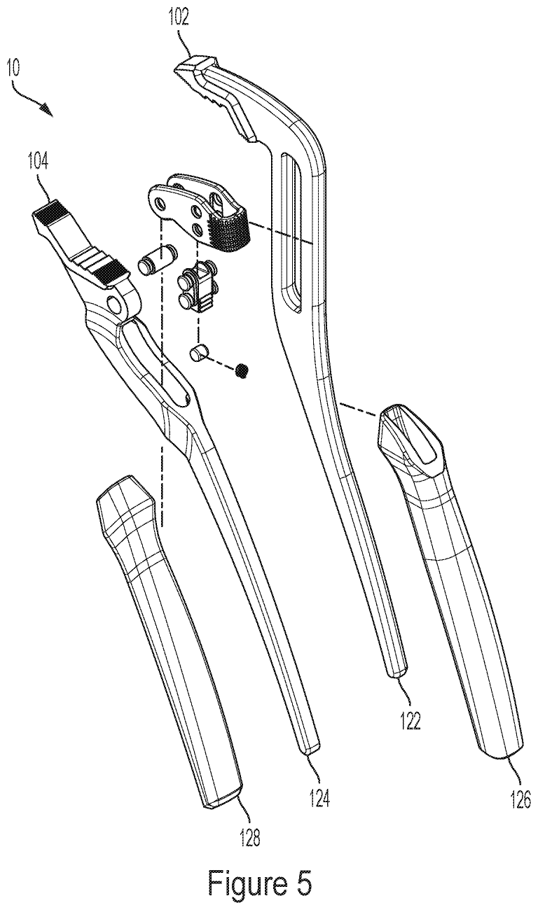

FIG. 5 is an exploded view of the adjusting plier device 10 of FIG. 1. As shown in FIG. 5, there is the top jaw 102, the bottom jaw 104, on the distal end of the top jaw is a bottom handle 122 and on the distal end of the bottom jaw 104 is a top handle 124. There is also depicted a handle cover 128 for the top handle 124 and a handle cover 126 for the bottom handle 122. The handles 126, 128 can be made of any polymer, elastomer, rubber, coating, or a combination thereof or any suitable material providing a user gripping surface.

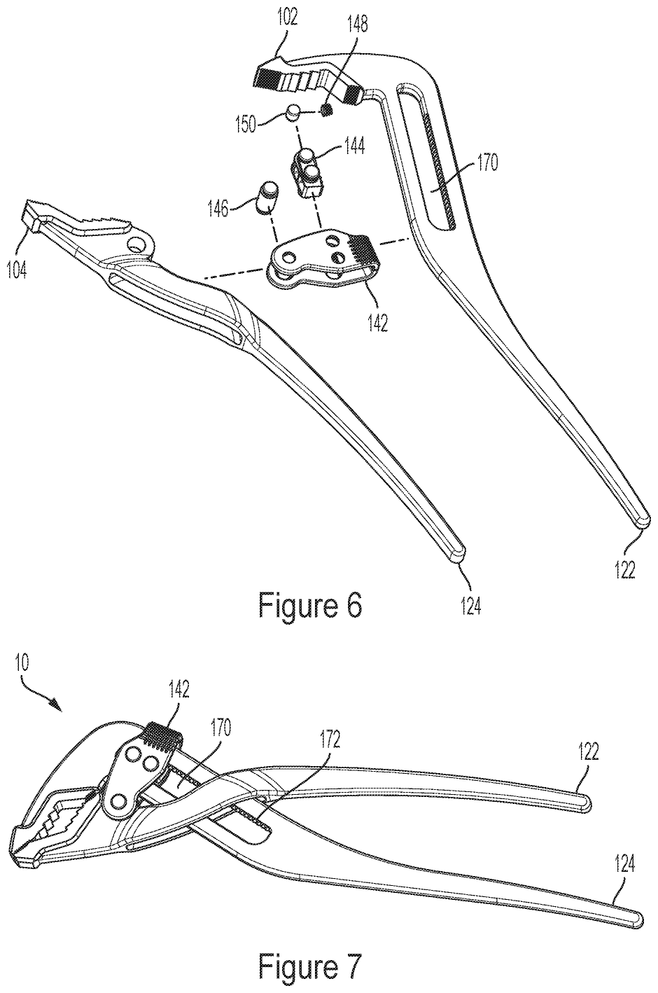

FIG. 6 is another exploded, perspective view of the adjusting plier device. As previously shown in FIG. 5, this Figure illustrates the top jaw 102, the bottom jaw 104, the top handle 124, and the bottom handle 122. Also shown in FIG. 6 is the pivot pawl assembly including a bearing element 150, such as a shoe, ball or roller, spring 148, a coupling, connecting or joining element 146, such as a pin or rivet, and the pawl 144, and the pivot pawl tactile exterior surface 142 that can be used to convey the force from a user to an integration joint, such as the coupling element 146 to at least one plier jaw. FIG. 7 is a side perspective view of the adjusting plier device with closed jaws. When user engage tactile surface 142 adjustment mechanism can provide haptic and audial feedback to the user along adjustment of the jaws apart and close to each other by sliding pivot pawl 144 along ridges 172. In this illustration the pivot pawl is engaged (pawl pivot teeth not shown) with the ridges 172 in the slot 170.

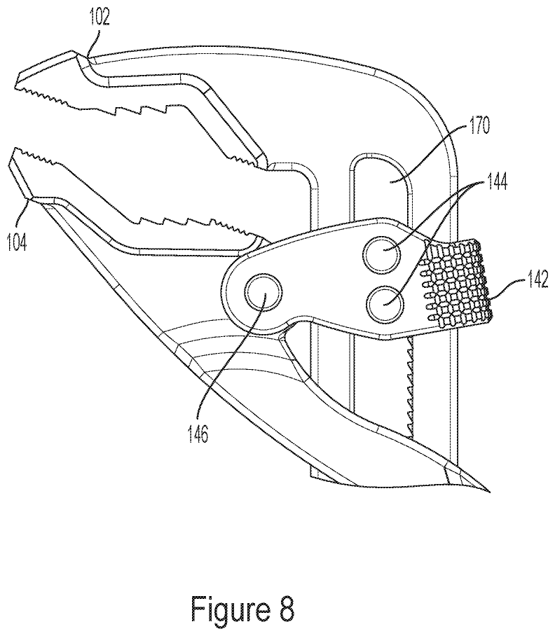

Now referring to FIG. 8 there is illustrated a partial side view of the adjusting plier device 10 of FIG. 1. The jaws 102, 104 are shown in an open position in response to adjustment of the pawl pivot 140 along a third axis.

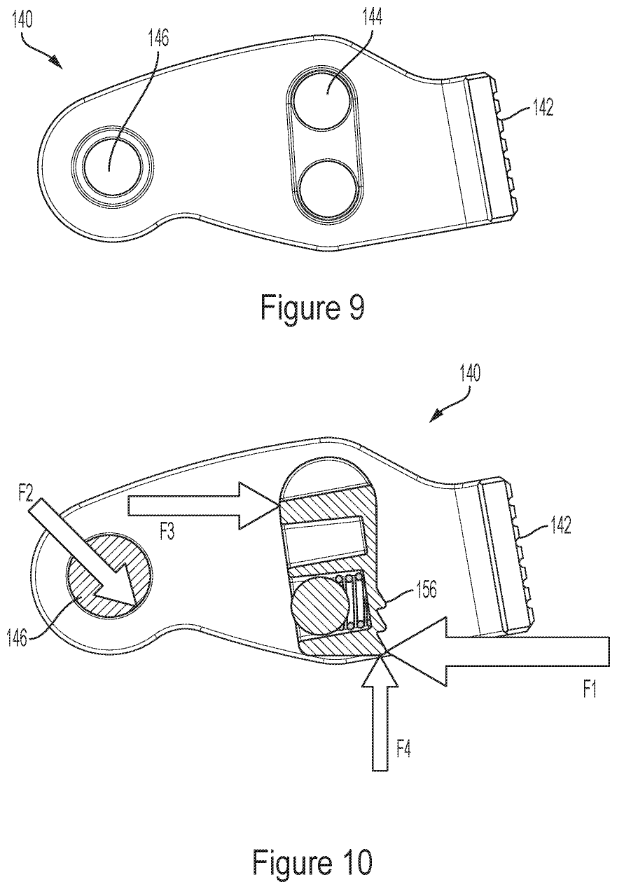

FIG. 9 is side view of the pivot pawl assembly 140. In this illustration the pawl pivot is illustrated with a tactile, ribbed exterior surface for easy user engagement 142. Although it is envisioned the exterior of the pawl pivot 142 includes a ribbed surface it is not limited in this regard and can include any tactile surface such as depressions, recesses, channels, or finger grips, etc. that is suitable to provide a gripping surface. In this Figure, the pivot pawl assembly 140 is shown including a tactile exterior surface 142, the pawl 144, a coupling, connecting or joining element, such as a pin or rivet 146, and a hole for receiving the coupling element 146.

FIG. 10 is illustration of the forces on the pawl pivot 140 shown from a cross section of the pawl pivot 140. In this Figure, F1 is the seating force of the pawl pivot teeth 156 into the adjustment ridges of the slot 170 (not shown). F2 is the force from the bottom jaw 104 transferred or translated to the pawl pivot 140 by the coupling element 146, such as a rivet. F3 is the force from the slide surface inside the slot 170 in the top jaw 102 on the pawl-pivot 140. F4 is the shear force of the pawl pivot teeth 156 on the adjustment ridges 172 in the slot 170.

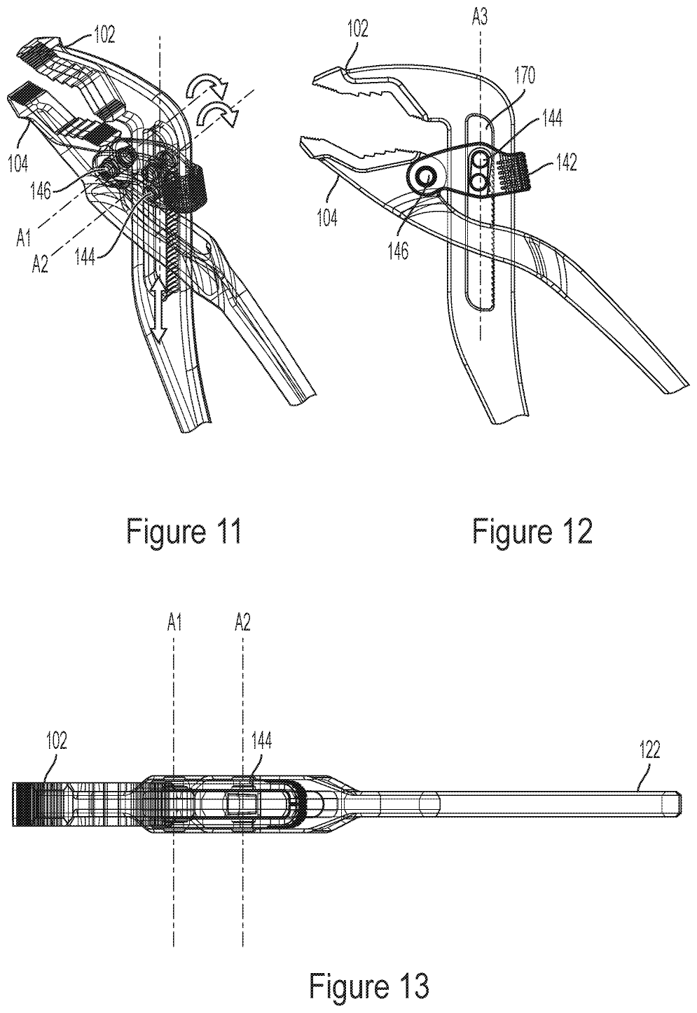

FIG. 11 is a perspective, wire frame view of a plier of FIG. 1 showing a coupling element 146 and the jaws 102, 104 that can pivot about a first axis A1 and a pivot pawl 144 that can pivot about a second axis A2. In this Figure, the plier jaws 102, 104 are open as both jaws can pivot via the coupling element 146 about the first axis A1.

FIG. 12 is a side view of the plier 10 of FIG. 1 showing a slot of the top jaw 102 as a third axis A3. In this Figure, the jaws 102, 104 are open as the pivot pawl 140 is moved up and down along engaging and disengaging via the pivot pawl teeth 156 along a third axis into and from ridges 172 in the slot 170. FIG. 13 is top, wire frame view of a plier of FIG. 1 showing the coupling element pivot about the first axis A1 and the pivot pawl assembly 140 being pivot about a second axis A2.

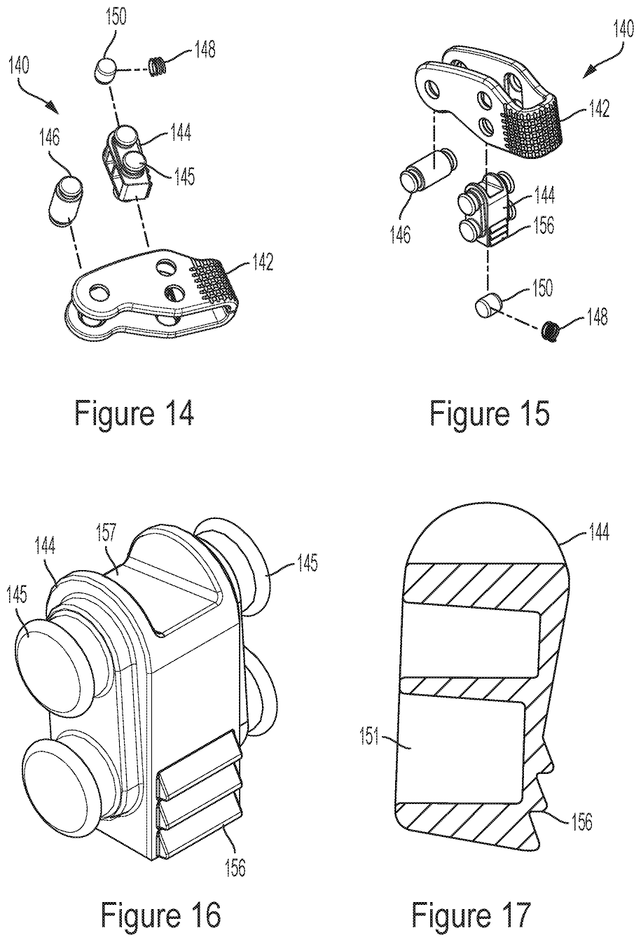

FIG. 14 is a perspective, exploded view of the pawl pivot assembly 140. The Figure depicts arrangement of the parts of the assembly 140 in alignment. The Figure includes the pawl 144 having a protrusion 145 for securement of the pawl 144 and other parts of the assembly 140. The Figure also depicts the bearing element 150, the tactile exterior surface 142 of the pawl pivot assembly, a plurality of protrusions 145 for engagement of the coupling element 146 into the pawl pivot cover 142, and a spring 148 for pushing or releasing force of the pawl pivot. FIG. 15 is another perspective view of the pawl pivot assembly 140 showing the parts in alignment from the bottom for arrangement into the assembly 140. The protrusions 145 of the pawl 144 of FIG. 14 are shown here in a side view unnumbered and are used to integrate and secure into place the walls of the surface 142 of the pawl pivot assembly The pawl teeth 156 are depicted in general alignment of and to placement in the surface 142 of the pivot pawl assembly.

FIG. 16 is perspective view of the pawl 144 in the pivot pawl assembly 140. In this illustration the pawl 144 is shown having an exterior recessed area 157 that may receive some material from the working part. The pawl teeth 156 is shown in a three-dimensional frame to illustrate a shape of the teeth 156 to engage with ridges of the slot (not shown). FIG. 17 is a cross-sectioned view of the pawl 144 showing recessed areas 151 for the bearing element 150 and the pawl teeth 156 configured to engage with the ridges 172 of the slot 170.

### Embodiment 2

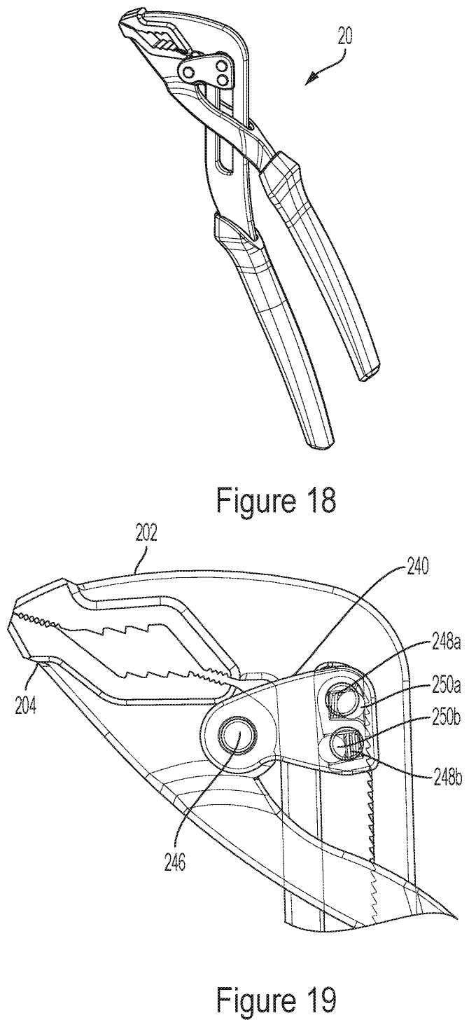

FIG. 18 is a perspective view of an adjusting plier device 20 according to a second embodiment of the present invention. The plier 20 has the functionality of quick or easy adjusting wherein the jaws can be moved closer together by adjusting mechanism with and without cam mechanism engagement via natural disengagement of pivot pawl self-energizing mechanism moving up along third axis A3. The plier has the functionality of quick or easy adjusting wherein the jaws can be moved apart by opening plier handles and engaging cam release mechanism via disengagement of pivot pawl self-energizing mechanism moving down along third axis A3, e.g. a self-energizing force from when the user grips at least part of the plier and applies force onto the handles resulting in the pawl pivot engaging or disengaging the ridges in a working position. The plier 20 can include haptic and audial feedback to the user along adjustment of the jaws apart and close to each other.

FIG. 19 is a side view of the adjusting plier 20 with partial cross sectioned view of the pivot pawl assembly 240. In this Figure the pivot pawl assembly 240 is shown collected and engaged with the slot of the top jaw 202. Also depicted are the coupling element 246, bearing elements 250a, 250b and springs 248a, 248b.

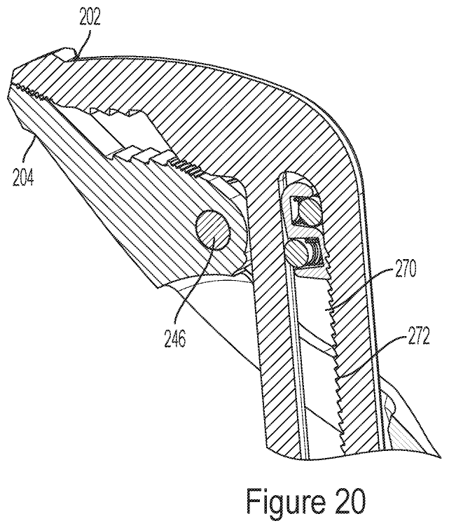

FIG. 20 is a partial cross-section of the adjusting plier of FIG. 20. As shown in the Figure, there is a top jaw 202, a bottom jaw 204, a plurality of ridges 272, a coupling, connecting or joining element, such as a rivet or pin 246 attached a pawl pivot assembly 240 to the jaws 202, 204, and a slot 270 in the top jaw 202.

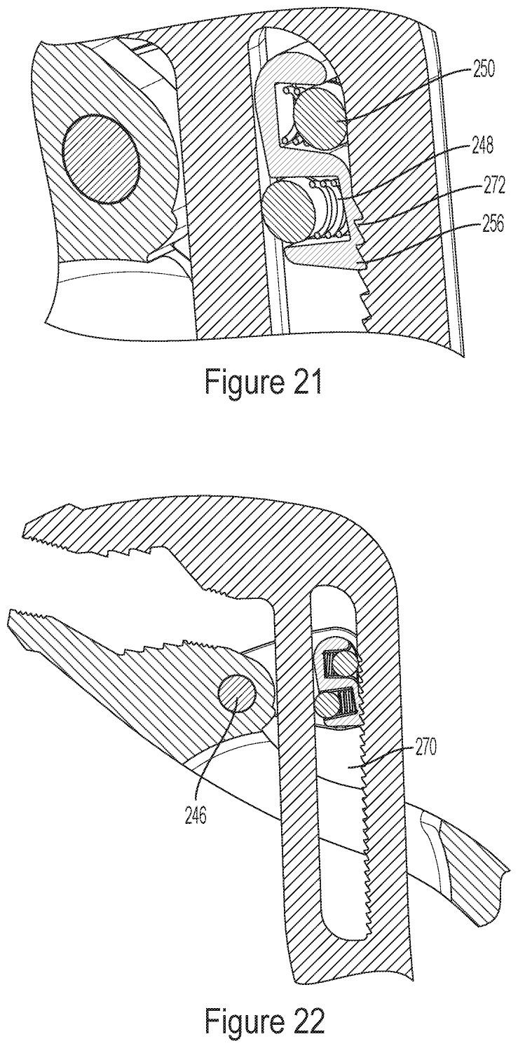

FIG. 21 is a close-up view of a pivot pawl 240 including bearing or sliding elements as shown in FIG. 19. Illustrated in FIG. 21 are bearing elements 250 that are to compress onto springs 248 to move teeth 256 of the pawl pivot 240 onto the ridges 272 of the slot 270, e.g. self-energizing the pawl pivot 240 onto ridges 272 in the working position. FIG. 22 is a cross-section view of an open jaw plier device 20 of FIG. 20.

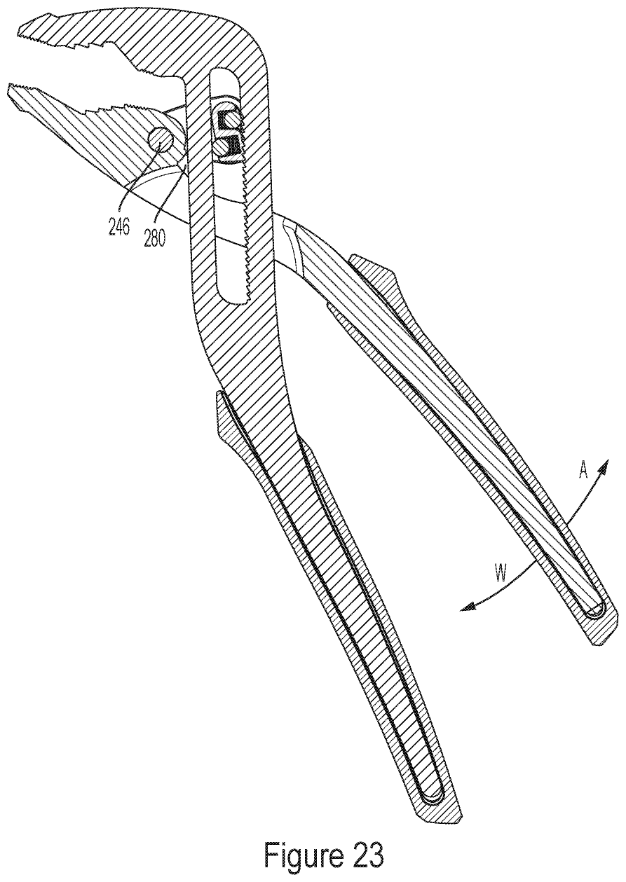

FIG. 23 is a cross-sectioned, side view adjusting plier device 20 of FIG. 22. In this Figure there is illustrated a release cam 280 on the bottom jaw 204 that is operatively engage or disengage the pawl pivot. The upward arrow “A” on the top handle represents the adjustment range of the plier 20 when the release cam is engagement. The downward arrow “W” on the top handle represents the working range when the release cam is disengaged.

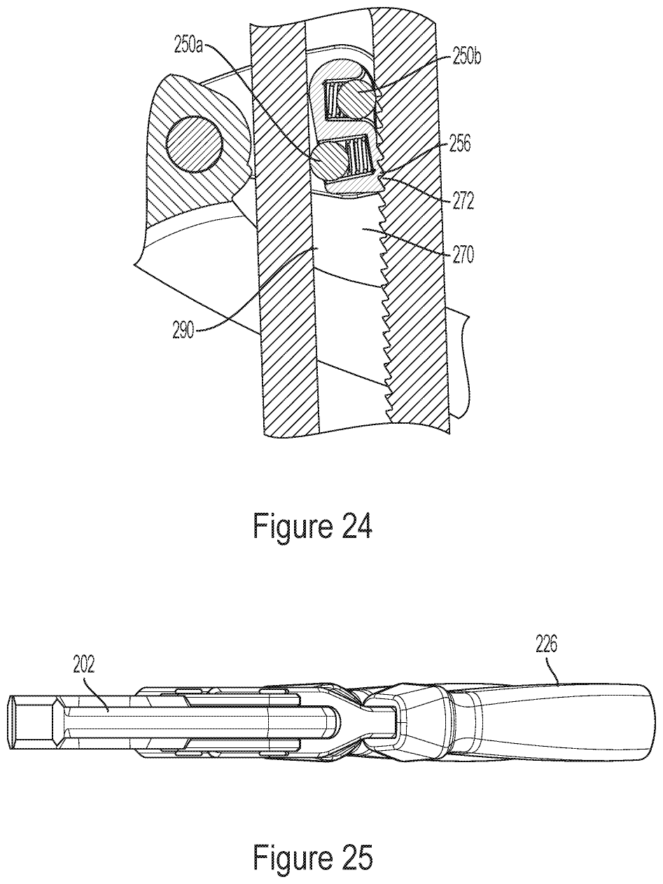

FIG. 24 is a close-up, partial view of the pivot pawl assembly 240 of FIG. 23. In this figure the bearing elements 250a, 250b are shown against a sliding surface 290 and teeth 256 of the pawl pivot 240 resting onto the ridges 272 in the slot 270. FIG. 25 is a top view of the adjusting plier device 20 of FIG. 18. The recessed areas of the top jaw 202 are shown and the top handle 226. The handle covers 226, 228 can be made of any of polymer, elastomer, rubber, plastic coating, a combination thereof or any suitable material providing a user gripping surface.

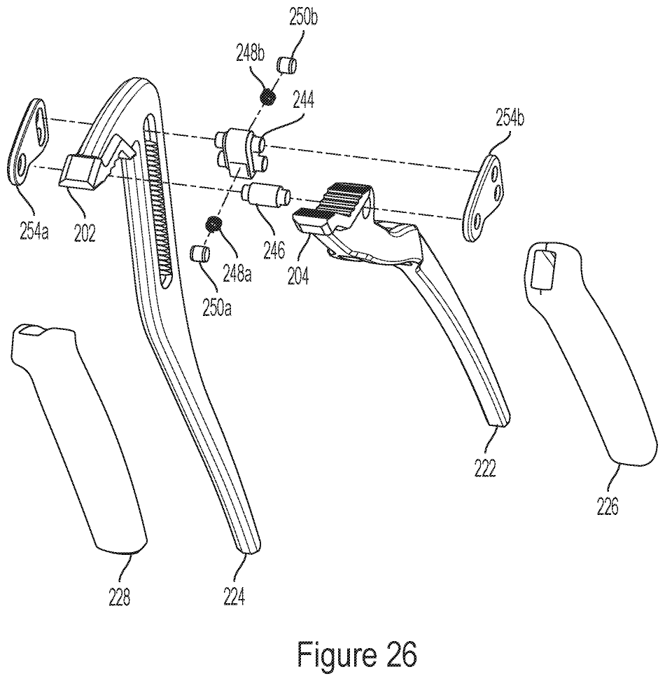

FIG. 26 is an exploded, perspective view of the adjusting plier device 20 of FIG. 18. As shown in FIG. 26, there is the top jaw 202, the bottom jaw 204, on the distal end of the top jaw is a bottom handle 224 and on the distal end of the bottom jaw 204 is a top handle 222. Further, the pawl 244, brackets 254a, 254b of the pivot pawl assembly 240 are separated from each other to show placement of the pawl 244, the coupling element 246, such as a rivet, and recesses 251 for receiving of springs 248a,248b and bearing element 250a, 250b. There is also depicted a handle cover 228 for the bottom handle 224 and a handle cover 226 for the top handle 222.

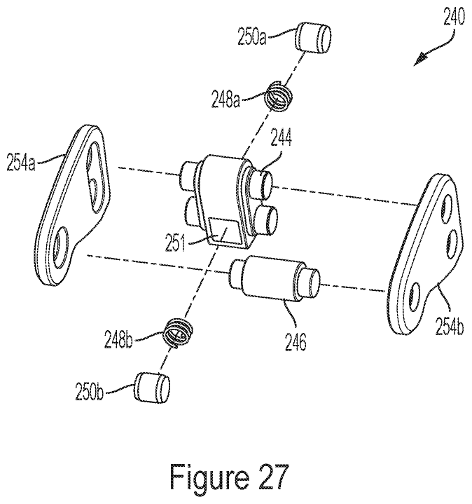

FIG. 27 is an exploded, perspective view of the pivot pawl assembly 240. As shown in this Figure, the pawl 244, brackets 254a, 254b of the pivot pawl assembly 240 are separated from each other to show placement of the pawl 244, the coupling element 246, such as a rivet. The pawl is also shown including recesses 251 for receiving of springs 248a, 248b and protrusions 245 for engagement into the bracket covers 254a, 254b.

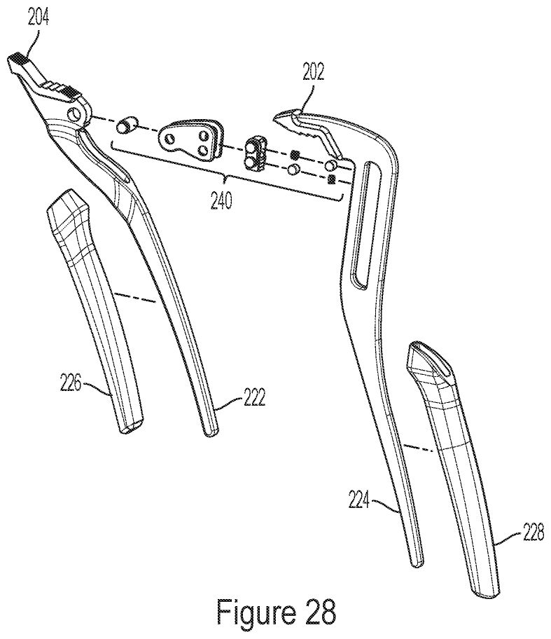

FIG. 28 is an exploded view of the plier tool 20 shown in substantial order of alignment or arrangement of the overall plier tool 20 framework. In this Figure, the parts are shown in general alignment to provide ease of view and assembly details. The pivot pawl assembly 240 from FIG. 27 is depicted in straight line arrangement.

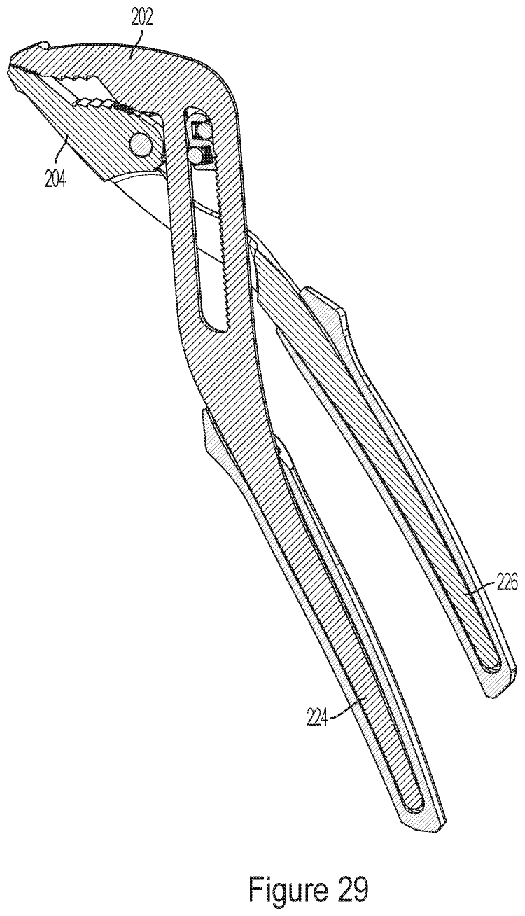

FIG. 29 is a side view of the adjusting plier 20 showing a cross-sectioned view plier jaws 202, 204 in a closed position. The pivot pawl is illustrated into placement of a different position onto the series of ridges 272 of the slot 270 of the bottom handle and the cam 280 disengagement has been moved in response to movement of the top handle 222 moved in one of two directions (see FIG. 23) that controls the working range of the plier tool 20.

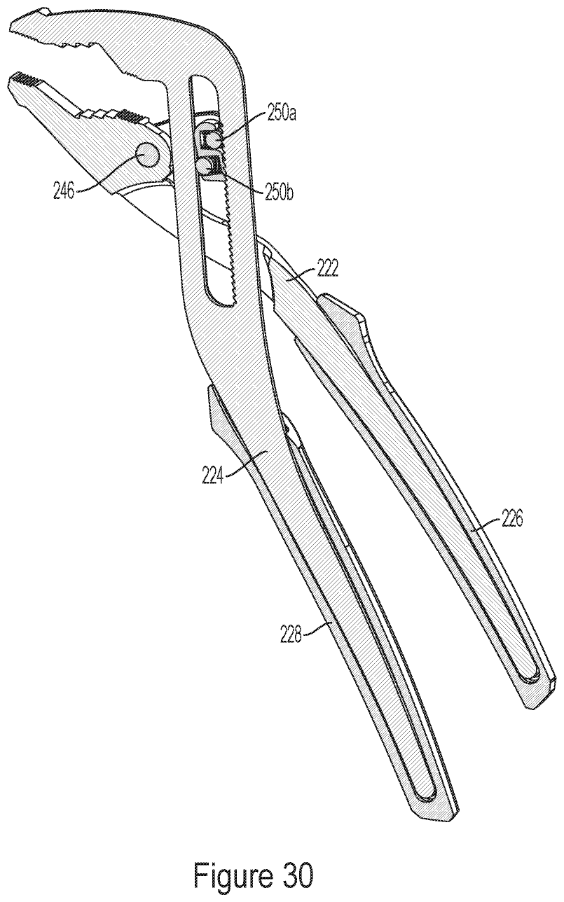

FIG. 30 is a side view of the adjusting plier 20 of FIG. 18 showing a cross-sectioned view of plier jaws 202, 204 in an open position and the pivot pawl into placement of one position onto the series of ridges 272 of the slot 270 of the bottom handle. FIG. 30 depicts one working range of the plier handles 226, 224, such as shown by the arrows A, W of FIG. 23.

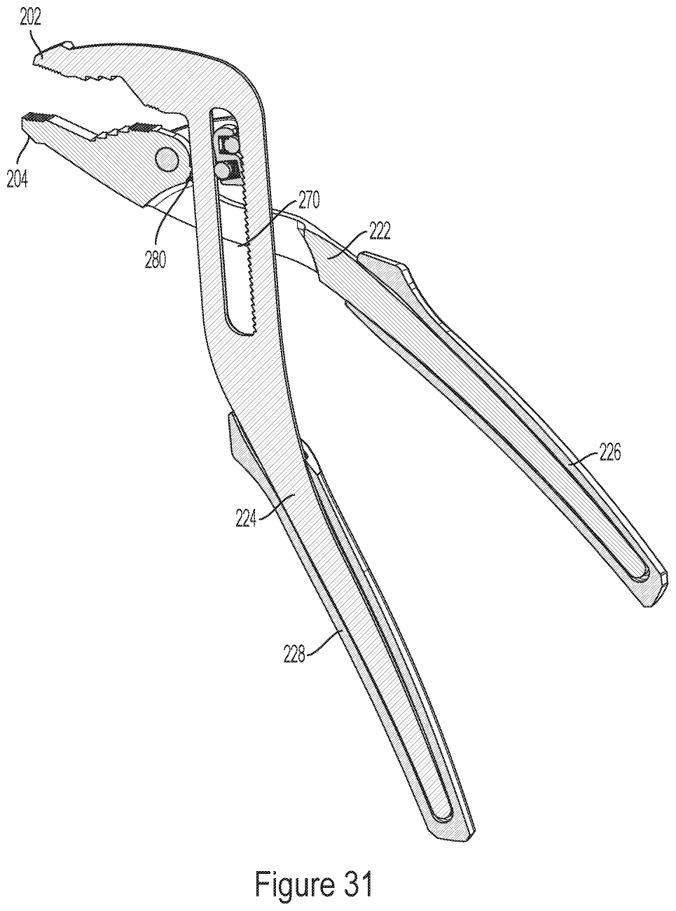

FIG. 31 is another side view of the adjusting plier 20 of FIG. 18 showing a cross-sectioned view of plier jaws 202, 204 in an open position and the pivot pawl into placement of another position onto the series of ridges 272 of the slot 270 of the bottom handle and the cam 280 engagement has been engaged in response to movement of the top handle 222 moved in an upward direction (see FIG. 23) that controls the adjustment range of the plier 20. In basic terms, movement of the top handle upwards can engage the cam 280 and release the teeth of the pawl pivot and movement of the top handle downwards can disengage the cam end release the cam 280.

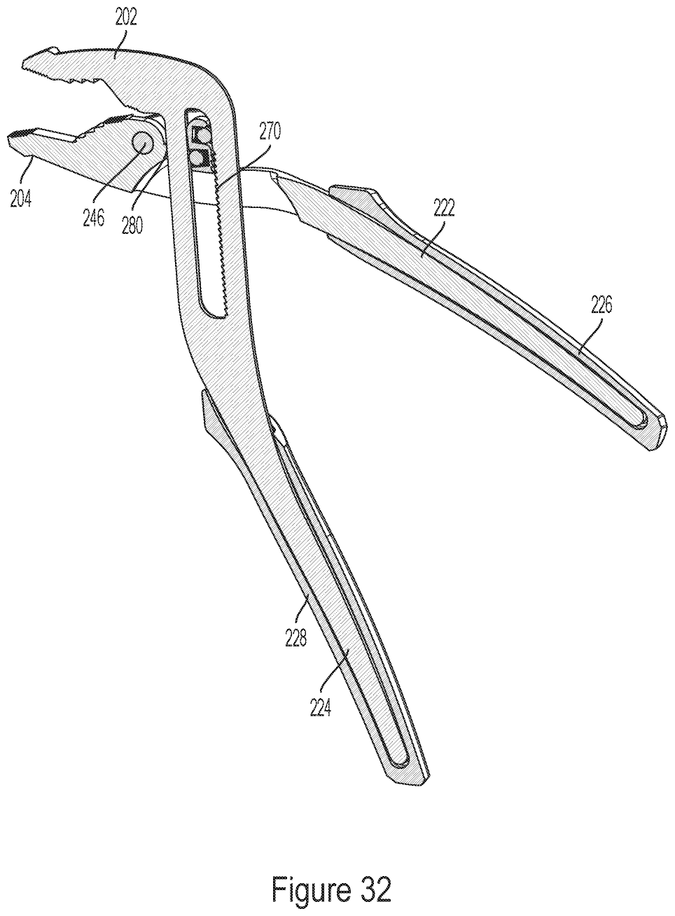

FIG. 32 is another side view of the adjusting plier 20 of FIG. 18 showing a cross-sectioned view of plier jaws 202, 204 in an open position and the pivot pawl 244 disengaged from series of ridges 272 of the slot 270 of the bottom handle and the cam 280 engagement has been engaged when the handles 222,224 are in an open position, such as in response to movement of the top handle 222 moved in an upward direction (see FIG. 23) that controls the adjustment range of the plier 20. FIG. 32 depicts a larger working range of the plier handles 226, 224, such as shown by the arrows A, W of FIG. 23, in relation to FIG. 32. In the event and when a user engages the cam 280 adjustment mechanism, the pivot pawl can provide haptic and audial feedback to the user along adjustment of the jaws apart and close to each other by sliding pivot pawl 244 along ridges 272.

### Third Embodiment

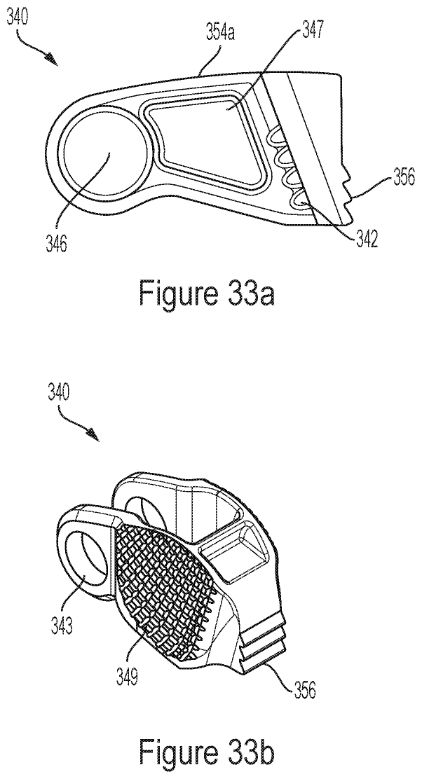

FIG. 33a is a side view of the pivot pawl 340 according to a third embodiment of the adjusting plier tool. In this Figure, the pawl 344 and the rivet 346 included into the pivot pawl. Also included in this Figure is the pivot pawl 340 is shown with side 354a, pawl teeth 356 and a tactile, recessed areas 347 for user gripping. FIG. 33b is another side view of the pivot pawl. FIG. 33b depicts the pivot pawl 340 from another angle and includes an aperture 343 where the rivet 346 can be placed into for rotation of the pivot pawl 340. The figure also includes another angle of the pawl teeth 356 for engagement or disengagement of the ridges in the slot and another tactile surface 349 that a user can provide a force onto for pawl engagement.

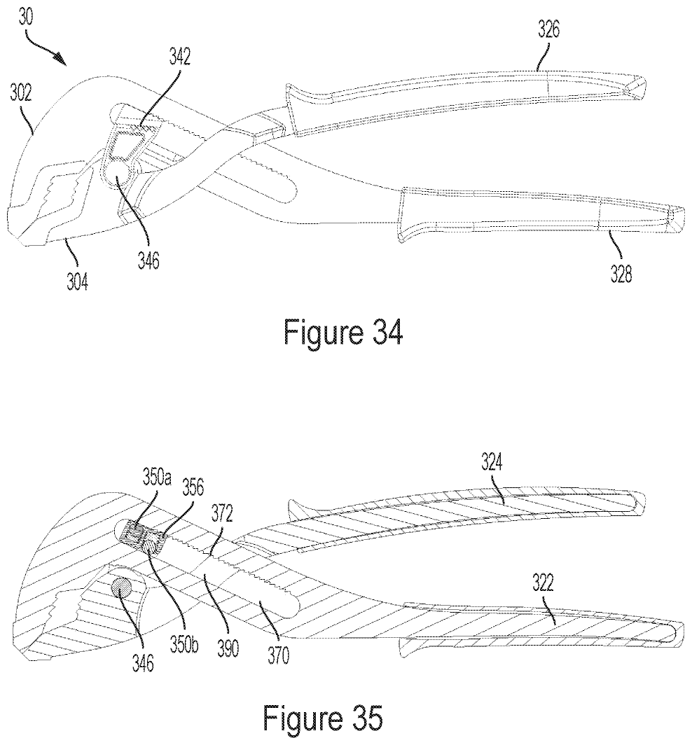

FIG. 34 is a side view of an adjusting plier 30 including the pivot pawl 340 of FIG. 34. In this Figure the pawl 344 is depicted as having an additional tactile surface area 342 on the pivot pawl 340, top jaw 302, bottom jaw 304, and polymer or elastomer handle covers 226, 228 for easy user engagement and gripping. The handle covers 326, 328 can be made of a, polymer, elastomer, plastic coating, a combination thereof or any suitable material providing a user gripping surface.

FIG. 35 is a cross-section of the entire adjusting plier 30 of FIG. 34 showing the pivot pawl 340 in placement into a series of ridges 372 of a slot 370. The pivot pawl teeth 356 can be pushed engaged or disengaged from the ridges of the slot 370 such as by pressing tactile surface 342.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

What is claimed is:

1. An adjusting plier device comprising:
a top jaw having a slot with a series of ridges and a bottom handle, wherein the ridges are located on at least one inner surface of the slot;
a pawl pivot that extends through at least one jaw, wherein at least part of the pawl pivot is configured to engage a plurality of the ridges located in the slot;
a bottom jaw, the bottom jaw having an opening and a top handle, wherein the bottom jaw is a part of the adjusting plier by the pawl pivot extending from part of the bottom jaw into the slot of the bottom handle of the top jaw, and wherein the top jaw is configured to be operatively connected to the bottom jaw through a space between the bottom jaw and the top handle;
an engagement element affixed to the pawl pivot, wherein the engagement element engages at least one of the series of ridges of the slot in a first position, wherein the top jaw and the bottom jaw pivot about a first axis, and
wherein the engagement element is movable along a second axis from the first position to a second position wherein the engagement element does not engage any of the series of ridges of the top jaw.

2. The adjusting plier device of claim 1, wherein a force on the pawl pivot translated from one of the plier elements is translated through the pawl pivot and causes the pawl pivot teeth to engage into at least one ridges of the slot of the bottom handle.

3. The adjusting plier device of claim 1, wherein the space of the bottom jaw includes an opening between the distal ends of the bottom jaw and the top handle and the opening is configured to hold a part of the top jaw or bottom handle.

4. The adjusting plier device of claim 1, wherein at least part of the pawl pivot includes a stop element that defines a stop point of perpendicular movement of the top handle in relation the slot of the top jaw.

5. The adjusting plier device of claim 4, wherein the top and bottom surfaces of the distal ends of the top jaw and the bottom handle engage with a plurality of engagement elements of the pawl pivot to prevent movement of the top handle along a third axis that is perpendicular to the first axis.

6. The adjusting plier device of claim 1, wherein the top and bottom surfaces of the distal ends of the top jaw and the bottom handle engage with a plurality of engagement elements of the pawl pivot to prevent movement of the bottom handle along an third axis that is perpendicular to the first axis.

7. The adjusting plier device of claim 1, wherein either the top handle or bottom handle is configured to move the top jaw or bottom jaw away from or toward each other as a result of force applied to the pawl pivot.

8. The adjusting plier device of claim 1, wherein the engagement element of the pawl pivot can translate along a third axis that is perpendicular to the first axis.

9. An adjusting plier comprising:
a top jaw having a bottom handle, a slot, and a series of ridges, wherein the ridges are on a surface of the slot;
a pawl pivot, wherein at least part of the pawl pivot extends into the slot, where the ridges are located around the slot;
a bottom jaw having a top handle, the bottom jaw defining an open space within said bottom jaw and top handle for receiving the top jaw and the bottom handle;
an engagement element attached to the pawl pivot, wherein the engagement element engages at least one of the series of ridges of the top jaw in a first position, wherein the top jaw and the bottom jaw pivot about a first axis, and
wherein the engagement element is movable along a second axis from the first position to a second position wherein the engagement element does not engage any of the series of ridges in the top jaw.

10. The adjusting plier of claim 9, wherein a force on the pawl pivot translated from one of the plier elements is translated through the pawl pivot and causes the pawl pivot teeth to engage into at least one ridges of the slot of the bottom handle.

11. The adjusting plier of claim 10, wherein the space of the bottom jaw includes an opening between the distal ends of the bottom jaw and the top handle and configured to hold a part of the top jaw or bottom handle.

12. The adjusting plier of claim 10, wherein at least part of the pawl pivot includes an engagement element that defines a stop point for perpendicular movement of the top handle in relation the slot of the top jaw.

13. The adjusting plier of claim 11, wherein the top and bottom surfaces of the distal ends of the top jaw and the bottom handle engage with a plurality of engagement elements of the pawl pivot to prevent movement of the top handle along a third axis that is parallel to the first axis.

14. The adjusting plier of claim 10, wherein the top and bottom surfaces of the distal ends of the top jaw and the bottom handle engage with a plurality of engagement elements of the pawl pivot to prevent movement of the top handle along a third axis that is perpendicular to the first axis.

15. The adjusting plier of claim 10, wherein either the top handle or bottom handle is configured to move the top jaw or bottom jaw away from or toward each other as a result of force applied to the pawl pivot.

16. The adjusting plier of claim 10, wherein the engagement element of the pawl pivot can translate along a third axis that is perpendicular to the first axis.

17. The adjusting plier of claim 11, wherein the bottom jaw is operatively fixed in the adjusting plier by placement of bottom handle into the opening between the bottom jaw and the top handle and affixed by the pawl pivot into a coupling element of the bottom jaw and an engagement element of the pawl pivot into the slot of the bottom handle.

18. The adjusting plier of claim 12, wherein the pawl pivot includes an engagement element defining a stop point for perpendicular movement of the top handle in relation to the slot in the top jaw.

19. An improved adjustable plier comprising:
a top jaw having a bottom handle, a slot, and a series of ridges on said top jaw, wherein the ridges are on an inner surface of the slot;
a pawl pivot operatively coupled to at least one jaw, wherein at least part of the pawl pivot is operatively coupled to one jaw that extends into the slot of the other jaw, wherein the ridges are located around the slot;
a bottom jaw having a top handle, the bottom jaw defining an open space within said bottom jaw and top handle for receiving the top jaw and the bottom handle;
an engagement element attached to the pawl pivot, wherein the engagement element engages at least one of the series of ridges in a first position, wherein the top jaw and the bottom jaw pivots about a first axis, and wherein the engagement element is movable along a second axis from the first position to a second position wherein the engagement element does not engage any of the series of ridges in the top jaw; and
wherein the pivot pawl is configured to receive a force from at least one jaw, wherein the force from at least one jaw is translated onto a coupling element of the at least one jaw to the pawl pivot and onto the teeth of the pawl pivot into a number of ridges of the slot of the corresponding other jaw.

20. The improved adjusting plier of claim 19, wherein force applied on at least one handle translates to the closing of the jaws, and wherein this force from the work piece is translated to the bottom jaw, and wherein the force from the bottom jaw is translated through coupling element to pawl pivot and causes the pawl teeth to engage into at least one ridge of the slot of the bottom handle.

21. The improved adjusting plier of claim 19, wherein the open space within the bottom jaw includes an opening between the distal ends of the bottom jaw and the top handle and wherein the opening is configured to hold a part of the top jaw.

22. The improved adjusting plier of claim 19, wherein at least part of the pawl pivot includes an engagement element that defines a stop point for perpendicular movement of the bottom handle in relation the slot of the top jaw.

23. The improved adjusting plier of claim 19, wherein the pawl pivot includes a plurality of recesses for containing ball plugs, shoes, springs, and or a combination thereof and adapted to engage the pawl pivot onto a surface of at least one jaw or handle.

24. The improved adjusting plier of claim 19, wherein force applied on the surface of the pawl pivot is configured to engage or disengage the pawl pivot from the ridges of the slot in the bottom handle.

25. The improved adjusting plier of claim 19, wherein at least a part of the pawl pivot translates along a third axis touching the ridges of the slot to provide a sensory feedback to the user.

26. The improved adjusting plier of claim 19, wherein the cam mechanism is located on at least of one of the plier parts and is configured to engage or disengage the pawl pivot from the ridges of the slot.

27. The improved adjusting plier of claim 19, wherein the cam mechanism is located on one of the plier jaws and configured to apply force on exterior surface of the pawl pivot to disengage teeth from at least one ridges on the slot in the bottom handle.
